(19) United States
(12) Patent Application Publication
(10) Pub. No.: US 2014/0283454 A1
(43) Pub. Date: Sep. 25, 2014

(54) Expandable shelf wall

(71) Applicant: Allyson Marie Willoughby, Hillsborough, CA (US)

(72) Inventor: Allyson Marie Willoughby, Hillsborough, CA (US)

(21) Appl. No.: 13/987,168

(22) Filed: Jul. 5, 2013

Related U.S. Application Data
(60) Provisional application No. 61/668,336, filed on Jul. 5, 2012.

(51) Int. Cl. A47B 45/00; E06B 7/28; A47B 96/02

(52) U.S. Cl. CPC A47B 45/00; A47B 96/02; E06B 7/28
USPC 49/381; 211/153; 49/506

(57) ABSTRACT

An expandable shelf is disclosed for use on a door of a refrigerator, cabinet, or other compartment. The expandable shelf includes a flexible member secured along edges thereof to the panel, such as by means of vertical supports positioned on either side of a horizontal support defining a shelf. The expandable shelf may be used to replace a rigid panel secured to the vertical supports and thereby expand the capacity of the shelf. In use items placed on the shelf may deflect the flexible member and the biasing force of the flexible member may retain the items on the shelf notwithstanding the item being only partially supported by the horizontal support.

### RELATED APPLICATION

This application claims the benefit of U.S. Provisional Application Ser. No. 61/668,336 filed Jul. 5, 2012 and entitled “Expandable Shelf Walls” (Attorney Docket No. WLBY-00100), which is hereby incorporated herein by reference in its entirety.

### FIELD OF THE INVENTION

The invention is directed to expandable shelf walls for use in cabinets, refrigerators, and the like.

### BACKGROUND

Storage areas such as refrigerators, cabinets, pantries and the like often have shelves with barrier walls to hold small items from falling off the shelf. For example, refrigerator doors have barrier walls configured to hold beverage and other food containers on a shelf when the door is opened and closed. Cabinets and pantries often have similar configurations. One problem with them is that standard sized items often have various widths, girths and lengths, and gaps often occur in the shelves, and shelves end up having wasted space. Also, it often occurs that a particular item only needs a small bit more space to fit on a shelf, but the rigid shelving barriers do not allow for the extra room to fit. Thus, users often end up trying to force or carefully organize items in shelves to fit everything. It would be useful if there were a way to somehow expand the shelves as needed, allowing extra items to fit. As will be seen, the invention provides such a solution.

### BRIEF DESCRIPTION OF THE FIGURES

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is an isometric view of a refrigerator in accordance with the prior art.

FIG. 2 is a top view of a refrigerator incorporating expandable shelves in accordance with an embodiment of the present invention.

FIG. 3 is an isometric view of an embodiment of expandable shelves in accordance with an embodiment of the present invention.

FIG. 4 is an isometric view of an alternative embodiment of an expandable shelf in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

The invention provides structures for retaining items on a shelf, yet allowing flexibility for items to fit when the shelf becomes full. In one example, flexible walls are provided that allow items to be placed on a shelf, and also allow flexibility to enable the flexible walls to give way, allowing items to fit on the shelf after it becomes full. As a result, less space is wasted.

The expandable walls on the shelves may be built into the refrigerator, cabinet or other storage area when purchased or designed by the manufacturer, or it may be a retrofit to existing storage areas. The built-in version would be fastened according to common manufacturing methods including but not limited to adhesives, snap-fit type fasteners, screws, nuts and bolts, slide fit assembly, and other types. The walls may be made of most any material that can be stretched, including flexible plastics, rubber, elastic cargo-type netting or other material.

Retrofit versions may include any of the above, and also configured to fit or fasten onto or inside such a storage space in an appropriate size. For example, a kit may be provided that includes a fastening set to attach to existing structure, replacement shelving that fits like other removable shelves in refrigerators or the like, and other materials configured to assemble and/or install the shelving and/or expandable shelving walls.

Reference is made to the attached drawings that illustrate examples of flexible shelving configured according to the invention.

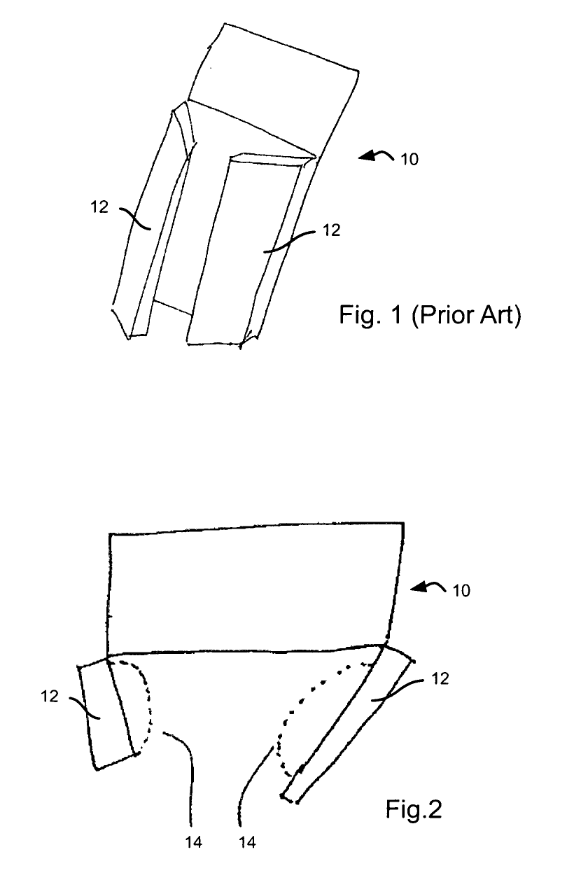

Referring to FIG. 1, a refrigerator 10 may include one or more doors 12 that are hingedly secured to the refrigerator and serve to close off the storage compartment of the refrigerator. Doors 12 may also secured to another structure such as a cabinet, armoire, chest, or other structure. Referring to FIG. 2, expandable shelves 14 as described herein may secure to an inner surface of the door 12.

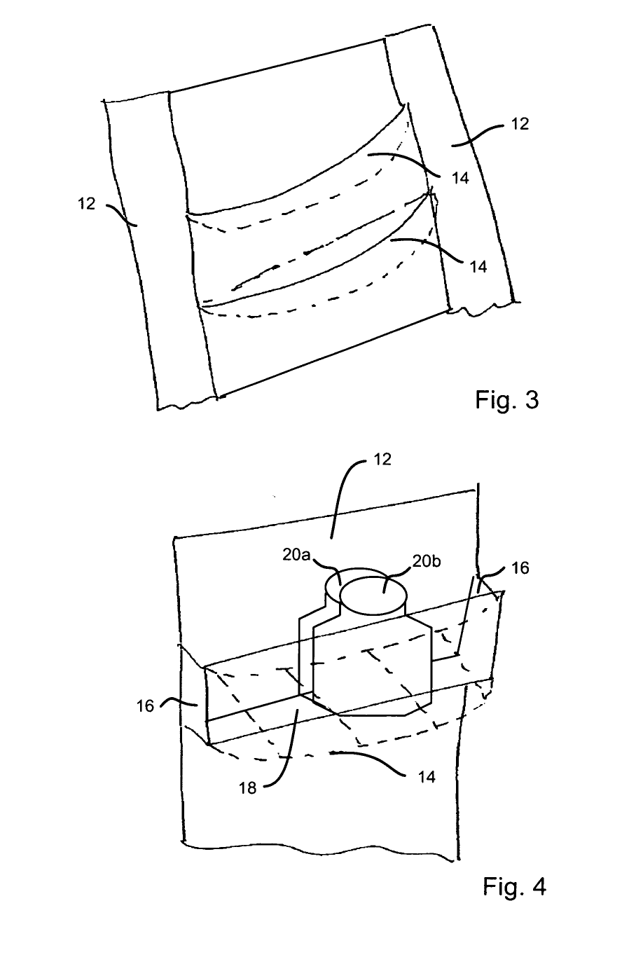

Referring to FIG. 3, in some embodiments, a shelf 14 may be a flexible sheet of material secured to a planar inner surface of the door 12 such that the flexible material forms a pocket for receiving items. The flexible material may secure along a lower edge thereof to the door 12 or only along right and left edges thereof, or one or more intermediate points, to the panel 12 by means of clips, screws, adhesive, or any other fastening means.

Referring to FIG. 4, in some applications a shelf secured to the door 12 may include vertical supports 16 that are horizontally offset from one another and extend outwardly from the door 12. A horizontal support 18 extends horizontally between the vertical supports 16 such that at least a portion of the vertical supports extend upwardly from an upper surface of the horizontal support 18. The horizontal support 18 defines a generally horizontal surface (+/−10 degrees, preferably 5 degrees) for vertically supporting items. The expandable shelf 14 may include a sheet of material secured to distal portions of the vertical supports 16. As shown in FIG. 4, the expandable shelf 14 is generally vertical (e.g. generally parallel to the door 12, e.g. +/−10 degrees, preferably 5 degrees) when undeformed and may bow outward in response to items 20a, 20b placed between the expandable shelf 14 and the door 12. In some embodiments, the expandable shelf 14 enables items to be placed such that one or more of the items 20a, 20b extend outwardly from the horizontal support 18 such that an item 20b would fall off the horizontal support 18 absent the expandable shelf 14. In this manner the capacity of the horizontal support 18 may be extended. For example, as shown in FIG. 4, a second item 20b may be placed adjacent an item 20a and outwardly therefrom relative to the door 12 but be retained due to the biasing action of the expandable shelf 14.

In use, the expandable shelf 14 may replace a rigid panel secured to the vertical supports 16. For purposes of this disclosure a flexible material for the expandable shelf 14 may include a material that has a modulus of elasticity of between 0.001 GPa and 0.2, preferably between 0.01 and 0.2 GPa. The expandable shelf 14 may include a continuous sheet of such material. A rigid panel replaced by the expandable shelf 14 may be made of a material having a higher modulus of elasticity, e.g. greater than 0.5 GPa. The expandable shelf 14 may secure to the vertical supports 16 by means of the same fastening means as the rigid panel, such as clips, other fasteners, or the like.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. An expandable shelf having shelves for holding items, comprising:
a flexible shelf wall; and
fasteners located on opposite ends of the flexible shelf to allow the flexible shelf wall to expand when items are placed on the shelf.

2. An expandable shelf according to claim 1, further configured for use on a refrigerator door to hold food items.

3. An expandable shelf according to claim 1, further configured for use on a pantry door to hold food or other items.

4. An expandable shelf according to claim 1, further configured for use on a cabinet door to hold items of various sizes.

5. A method comprising:
providing a shelf secured to a hinged panel, the shelf defining a horizontal support secured to the hinged panel and two vertical supports extending above the horizontal support and having at least a portion of the horizontal support extending therebetween; and
securing a flexible member to distal end portions of the two vertical supports such that the flexible member and hinged panel define a space for receiving items.

6. The method of claim 5, further comprising:
removing a rigid member secured to distal end portions of the two vertical supports prior to securing the flexible member to the distal ends of the two vertical supports, the rigid member being less flexible than the flexible member.

7. The method of claim 5, further comprising:
placing an item on the shelf having the item resting on the horizontal support having a portion of the item extending outwardly from the horizontal support;
deflecting the flexible member outwardly from the horizontal support such that a biasing force of the flexible member retains the item on the shelf.

8. The method of claim 5, wherein the flexible member is formed of a resilient polymer.

9. The method of claim 5, wherein the hinged panel is a door of a refrigerator.

10. An apparatus comprising:
a hinged panel configured to secure to a storage structure;
a horizontal support secured to an inner surface of the hinged panel;
at least two vertical supports secured to the storage structure and extending above the horizontal support and having at least a portion of the horizontal support extending therebetween; and
a flexible member secured to distal end portions of the two vertical supports and spanning between the vertical supports, the flexible member including a sheet of material oriented generally parallel to the hinged panel when undeformed.
